(19) United States
(12) Patent Application Publication
(10) Pub. No.: US 2019/0206620 A1
(43) Pub. Date: Jul. 4, 2019

(54) OIL-BASED MAGNETIC INKJET INK

(71) Applicant: RISO KAGAKU CORPORATION, Tokyo (JP)

(72) Inventors: Kenji YAMADA, Tsukuba-shi (JP); Yoshifumi WATANABE, Tsukuba-shi (JP)

(21) Appl. No.: 16/235,103

(22) Filed: Dec. 28, 2018

(30) Foreign Application Priority Data
Dec. 28, 2017 (JP) 2017-252967

(51) Int. Cl. H01F 41/16; H01F 1/00

(52) U.S. Cl. CPC H01F 41/16; H01F 1/0027

(57) ABSTRACT

An oil-based magnetic inkjet ink that prevents any increase in ink viscosity over a long period of time can be provided. The oil-based magnetic inkjet ink contains a magnetic pigment containing a ferrite, a dispersant, a non-aqueous solvent, and an organometallic chelate compound. This organometallic chelate compound may include an organoaluminum chelate compound.

### CROSS REFERENCE TO RELATED APPLICATIONS

This application is based upon and claims the benefit of priority from prior Japanese Patent Applications No. 2017-252967 filed on Dec. 28, 2017, the entire contents of which are incorporated by reference herein.

### BACKGROUND OF THE INVENTION

### Field of the Invention

The present invention relates to an oil-based magnetic inkjet ink.

### Description of the Related Art

Magnetic printing, which is used for forming images containing a magnetic pigment, is a known type of secure printing technique that can be used for printing checks and paper money. One known method for using a magnetic head to read magnetic information that has been printed with a magnetic ink is a magnetic ink character recognition (MICR) system. This magnetic ink contains a magnetic pigment, and an iron oxide or ferrite or the like is generally used.

Examples of known printing methods conventionally used for magnetic printing include methods that use a magnetic toner or a magnetic ink ribbon, but in recent years, for reasons including printing costs, much development has focused on inkjet printing methods using a magnetic ink.

JP 2012-233053 A (Patent Document 1) proposes an aqueous magnetic inkjet ink containing magnetic particles composed of a cobalt-manganese ferrite represented by MnₓCo_{y}Fe₂O₄ (x+y=1, and x/y is at least 0.5 but not more than 0.9) dispersed in an aqueous dispersion medium, wherein a specific amine salt of diphosphonic acid is used as a dispersion stabilizer.

On the other hand, in the case of oil-based inkjet inks, because the amount of volatile components contained in the ink is small, any change in the viscosity of the ink in the vicinity of head nozzles that have been left to stand idle is small, meaning discharge recoverability is excellent, and because the oil component does not cause swelling of the printing paper fibers like water, curling of the paper is minor.

Accordingly, oil-based inks are suitable for high-speed inkjet color printers.

JP 2016-221807 A (Patent Document 2) proposes a magnetic printing method suited to inkjet printing in which, by printing an oil-based magnetic ink having a magnetic pigment and subsequently printing a color ink having a colorant, an image having favorable magnetic characteristics together with a desired hue can be provided.

JP 2016-124910 A (Patent Document 3) discloses that in inkjet non-aqueous inks containing a carbon black, when a carbon black having a small primary particle size is used, although the image density, glossiness and abrasion resistance can be improved, a problem arises in that the ink viscosity increases as the primary particle size of the carbon black is reduced, resulting in a deterioration in the discharge performance.

Patent Document 3 discloses that by adding an aluminum chelate to the ink, the aluminum chelate can function as a type of auxiliary agent that facilitates adsorption of the carbon black and the pigment dispersant, and can therefore improve the dispersion stability.

In oil-based magnetic inkjet inks, because the non-aqueous solvent itself has a comparatively high viscosity, a problem arises in that the ink viscosity tends to increase easily. Further, if the blend amount of the magnetic pigment is increased to enhance the strength of the magnetic readability, then the ink viscosity tends to increase even further.

Patent Document 2 discloses the use of a combination of a magnetic pigment and a pigment dispersant in an oil-based magnetic inkjet ink. Magnetic pigments have a larger specific gravity than typical pigments such as carbon black, and further improvements in the dispersion stability and storage stability can be expected.

However, because magnetic pigments have a large specific gravity, they tend to precipitate within the ink as time passes. Precipitation causes the distance between magnetic pigment particles to shorten, which can sometimes lead to pigment aggregation.

Patent Document 3 discloses that in oil-based inkjet inks, an aluminum chelate can function as an auxiliary agent that facilitates adsorption of carbon blacks having a small primary particle size and the pigment dispersant. These carbon blacks have a small specific gravity, and once dispersed in the ink, tend not to suffer from subsequent precipitation.

Further, in oil-based inkjet inks, the blend amount of the pigment such as the carbon black is typically about 0.1 to 20% by mass relative to the total mass of the ink. If the pigment is included in an amount greater than this range, then a decrease in the dispersion stability of the pigment can become problematic.

One object of the present invention is to provide an oil-based magnetic inkjet ink that prevents any increase in ink viscosity over a long period of time.

### SUMMARY OF THE INVENTION

One embodiment of the invention provides an oil-based magnetic inkjet ink containing a magnetic pigment that contains a ferrite, a pigment dispersant, a non-aqueous solvent, and an organometallic chelate compound.

### DETAILED DESCRIPTION OF THE EMBODIMENTS

The present invention is described below using embodiments. However, examples presented in the following embodiments in no way limit the present invention.

An oil-based magnetic inkjet ink according to one embodiment (hereafter sometimes referred to as simply “the ink”) contains a magnetic pigment containing a ferrite, a pigment dispersant, a non-aqueous solvent, and an organometallic chelate compound.

As a result, an oil-based magnetic inkjet ink can be provided that prevents any increase in ink viscosity over a long period of time. For example, even in those cases where the magnetic pigment precipitates within an ink container, any increase in the ink viscosity following redispersion of the pigment can be prevented.

Magnetic pigments have a large specific gravity and are therefore difficult to disperse stably within non-aqueous solvents. Even if a large amount of a pigment dispersant is added to improve the dispersibility, a satisfactory improvement in the dispersibility is difficult to achieve, and an increase in the ink viscosity often occurs. Particularly in the case of magnetic pigments containing a ferrite, satisfactory dispersibility tends to be difficult to obtain using only a pigment dispersant.

Further, because of the large specific gravity, magnetic pigments tend to precipitate within the ink, and a phenomenon occurs wherein a concentration gradient develops in which the concentration of the magnetic pigment increases in the lower portion of the ink container. When magnetic pigment that has precipitated is redispersed, the ink viscosity may sometimes increase. This is because if the magnetic pigment precipitates and particles of the magnetic pigment adsorb to one another, then separating the particles is difficult, which tends to lead to problems of aggregation. Further, if the magnetic pigment precipitates and the distance between magnetic pigment particles shortens, then interactions with the surrounding pigment dispersant can also cause degeneration of the magnetic pigment or the type of aggregation described above, making it difficult to return the ink to the state prior to precipitation.

By adding an organometallic chelate compound to the oil-based magnetic inkjet ink, the redispersibility of the ink can be improved while preventing any increase in the ink viscosity.

It is thought that this is because a chelate exchange between the organometallic chelate compound and OH groups on the surface of the magnetic pigment modifies the magnetic pigment surface, thereby improving the dispersibility of the magnetic pigment before and after storage. As a result, any increase in the ink viscosity can be prevented, and ink viscosity increases can be prevented over a long period of time, even in high-temperature environments. Further, as a result of the surface modification, even if the magnetic pigment precipitates and particles of the magnetic pigment approach one another, aggregation that prevents redispersion tends not to occur, and stability can be maintained. For example, when the ink is stored in a container, even when the magnetic pigment is prone to precipitation, redispersion following storage is able to prevent any increase in the ink viscosity, and the dispersion stability can be enhanced.

The magnetic ink preferably contains a magnetic pigment.

This magnetic pigment is composed of particles formed from a magnetic material. Although dependent on the type of magnetic material used, if the magnetic material contains no colorant, then black magnetic pigments are the most common.

A ferromagnetic material such as a ferrite can be used favorably as the magnetic pigment.

The ferrite preferably exists in the form of a solid solution with any of various metal oxides. For example, the ferrite may contain any one of iron (Fe), cobalt (Co), nickel (Ni), manganese (Mn), barium (Ba), strontium (Sr), copper (Cu), zinc (Zn), or lead (Pb) or the like, or may contain a mixture of two or more of these metals.

Specific examples of the magnetic pigment include ferrite particles containing cobalt, ferrite particles containing cobalt and manganese, and ferrite particle containing barium.

The average primary particle size of the magnetic pigment may be at least 5 nm, and is preferably at least 20 nm, and more preferably 24 nm or greater.

Further, the average primary particle size of the magnetic pigment is typically not more than 300 nm, and is preferably not more than 200 nm, and more preferably 150 nm or less.

In one embodiment, even in the case of a magnetic pigment having a large particle size and a large specific gravity, the dispersion stability within the ink can still be maintained favorably over a long period of time.

The average primary particle size of the magnetic pigment can be calculated from the lengths of particles observed using a scanning electron microscope (SEM). In a specific example, ten particles are selected from among the magnetic pigment particles contained within a 1 μm×1 μm region in an SEM observation, the lengths of those primary particles are measured, and the average primary particle size can then be determined as the average of the measured values.

The amount of the magnetic pigment, relative to the total mass of the ink, is preferably at least 1% by mass, more preferably at least 10% by mass, even more preferably at least 20% by mass, and still more preferably 30% by mass or greater. This ensures that the legibility of the printed image and the magnetic strength can be enhanced.

The amount of the magnetic pigment, relative to the total mass of the ink, is preferably not more than 50% by mass, and more preferably 45% by mass or less. Although the magnetic pigment has a high specific gravity and tends to be prone to a deterioration in redispersibility upon precipitation, by using the organometallic chelate compound, favorable redispersibility can be maintained even at high concentrations of the magnetic pigment, and any increase in the ink viscosity can also be prevented.

The magnetic ink preferably contains an organometallic chelate compound.

Examples of the central metal in the organometallic chelate compound include aluminum (Al), copper (Cu), manganese (Mn), nickel (Ni) and vanadium (V).

The organometallic chelate compound may contain one or two or more polydentate ligands, and depending on the valence of the central metal, all of the ligands may be polydentate ligands, or a portion of the ligands may be monodentate ligands.

The organometallic chelate compound preferably includes at least one organic ligand, it is more preferable that at least one polydentate ligand is an organic ligand, and all of the polydentate ligands may be organic ligands.

In the organometallic chelate compound, the polydentate ligand may be a bidentate ligand, a tridentate ligand, or a tetradentate or higher ligand, but is preferably a bidentate ligand or tridentate ligand, and is more preferably a bidentate ligand.

Examples of the polydentate ligand include β-ketoesters and derivatives thereof such as alkyl acetoacetate such as methyl acetoacetate, ethyl acetoacetate and isopropyl acetoacetate, ethyl propanoyl acetate, and ethyl butanoyl acetate; β-diketones and derivatives thereof such as acetylacetonate, 3,5-heptadione, and 6-methyl-2,4-heptadione; and octylene glycolate.

Among these, β-diketones, β-ketoesters, and derivatives thereof can be used particularly favorably as the polydentate ligand.

In those cases where the organometallic compound includes a monodentate ligand, the monodentate ligand may be either an inorganic ligand or an organic ligand, but is preferably an organic ligand.

Examples of monodentate ligands include alkoxy groups of 1 to 4 carbon atoms such as a methoxy group, ethoxy group, propoxy group, isopropoxy group and butoxy group.

A compound represented by general formula (1) shown below may be used as the organometallic chelate compound.

(R¹)_{a-b}M(R²)_{b} (1)

In general formula (1), M represents the central metal, R¹ represents a polydentate ligand, R² represents a monodentate ligand, a represents an integer equal to the valence of M, and b represents an integer from 0 to (a-1).

The central metal represented by M, the polydentate ligand represented by R′, and the monodentate ligand represented by R² are as described above.

When a-b is 2 or greater, the polydentate ligands represented by R¹ may be the same or different.

When b is 2 or greater, the monodentate ligands represented by R² may be the same or different.

An organoaluminum chelate compound can be used favorably as the organometallic chelate compound.

An organoaluminum chelate compound is a compound in which the central metal is trivalent aluminum, and which has at least one polydentate ligand, and is preferably a compound having two or three polydentate ligands, and more preferably a compound having three polydentate ligands.

The polydentate ligand in the organoaluminum chelate compound is preferably a bidentate ligand or tridentate ligand, and a bidentate ligand and a tridentate ligand may both exist in the same molecule.

Specific examples of organoaluminum chelate compounds include alkyl acetoacetate aluminum diisopropylates such as ethyl acetoacetate aluminum diisopropylate, as well as aluminum tris(ethyl acetoacetate), aluminum tris(acetylacetonate), and aluminum mono(acetylacetonate) bis(ethyl acetoacetate).

One of the above organometallic chelate compounds may be used alone, or a combination of two or more compounds may be used. Among the various compounds, those that dissolve or disperse in non-aqueous solvents are preferred, and oil-soluble organometallic chelate compounds are particularly preferred.

The mass ratio of the organometallic chelate compound relative to the magnetic pigment [(mass of organometallic chelate compound)/(mass of magnetic pigment)×100] is preferably at least 0.1%, more preferably at least 0.5%, even more preferably at least 1%, and still more preferably 1.5% or greater. Ensuring such a mass ratio means that even if the magnetic pigment precipitates during ink storage, subsequent redispersibility of the magnetic pigment can be improved, and any increase in the ink viscosity following redispersion can be prevented.

This mass ratio [(mass of organometallic chelate compound)/(mass of magnetic pigment)×100] is, for example, typically not more than 15%, and is preferably less than 10%, more preferably not more than 5%, and may be 3% or less. The effects of the organometallic chelate compound can be obtained even when the compound is added to the ink in a small amount.

Further, the organometallic chelate compound may be added to the ink in an amount of 0.1 to 10% by mass relative to the total mass of the ink, and this amount is preferably from 0.1 to 5% by mass, and may be from 1 to 3% by mass.

In order to achieve stable dispersion of the magnetic pigment within the magnetic ink, a pigment dispersant may also be added.

Examples of pigment dispersants that can be used favorably include hydroxyl group-containing carboxylic acids, hydroxyl group-containing carboxylate esters, salts of long-chain polyaminoamides and high-molecular weight acid esters, salts of high-molecular weight polycarboxylic acids, salts of long-chain polyaminoamides and polar acid esters, high-molecular weight unsaturated acid esters, copolymers of vinylpyrrolidone and long-chain alkenes, modified polyurethanes, modified polyacrylates, polyether ester anionic surfactants, polyoxyethylene alkyl phosphate esters, and polyester polyamines.

A basic dispersant is preferably used as the pigment dispersant.

Examples of commercially available pigment dispersants include Antaron V216 (a vinylpyrrolidone-hexadecene copolymer) and V220 (a vinylpyrrolidone-eicosene copolymer) (both product names), manufactured by ISP Japan Ltd.; Solsperse 13940 (a polyester amine-based dispersant), 16000, 17000 and 18000 (fatty acid amine-based dispersants), and 11200, 24000, 28000 and 21000 (all product names), manufactured by The Lubrizol Corporation; Efka 400, 401, 402, 403, 450, 451 and 453 (modified polyacrylates) and Efka 46, 47, 48, 49, 4010 and 4055 (modified polyurethanes) (all product names), manufactured by BASF Japan Ltd.; Disparlon KS-860 and KS-873N4 (polyester amine salts) (both product names), manufactured by Kusumoto Chemicals, Ltd.; Discol 202, 206, OA-202 and OA-600 (multi-chain polymeric nonionic dispersants) (all product names), manufactured by DKS Co., Ltd.; DISPERBYK 2155 and 9077 (both product names). manufactured by BYK-Chemie Japan K.K.; HINOACT KF1300M, manufactured by Kawaken Fine Chemicals Co., Ltd.; and Hypermer KD2, KD11, KD12 and LP5 (all product names), manufactured by Croda Japan K.K.

The amount of the pigment dispersant need only be sufficient to enable satisfactory dispersion of the magnetic pigment within the ink, and may be set as appropriate.

The mass ratio of the pigment dispersant relative to the magnetic pigment [(mass of pigment dispersant)/(mass of magnetic pigment)×100] is preferably at least 1%, more preferably at least 5%, and even more preferably 10% or greater.

This mass ratio [(mass of pigment dispersant)/(mass of magnetic pigment)×100] is preferably not more than 50%, more preferably not more than 20%, and even more preferably 18% or less.

Further, the pigment dispersant may be added to the ink in an amount of 0.1 to 10% by mass relative to the total mass of the ink, and this amount is preferably from 1 to 6% by mass.

As a result of adding the organometallic chelate compound to the ink, the effects of the pigment dispersant manifest efficiently, meaning satisfactory dispersion stability of the magnetic pigment can be achieved with an amount of the pigment dispersant that falls within the above range.

Both non-polar organic solvents and polar organic solvents can be used as the non-aqueous solvent. In one embodiment, a water-insoluble organic solvent that does not mix uniformly with an equal volume of water at 1 atmosphere and 20° C. is preferably used as the non-aqueous solvent.

Examples of preferred non-polar organic solvents include petroleum-based hydrocarbon solvents such as aliphatic hydrocarbon solvents, alicyclic hydrocarbon solvents and aromatic hydrocarbon solvents.

Examples of the aliphatic hydrocarbon solvents and alicyclic hydrocarbon solvents include paraffin-based, isoparaffin-based, and naphthene-based non-aqueous solvents. Specific examples of preferred commercially available products include No. 0 Solvent L, No. 0 Solvent M, No. 0 Solvent H, Cactus Normal Paraffin N-10, Cactus Normal Paraffin N-11, Cactus Normal Paraffin N-12, Cactus Normal Paraffin N-13, Cactus Normal Paraffin N-14, Cactus Normal Paraffin N-15H, Cactus Normal Paraffin YHNP, Cactus Normal Paraffin SHNP, Isosol 300, Isosol 400, Teclean N-16, Teclean N-20, Teclean N-22, AF Solvent No. 4, AF Solvent No. 5, AF Solvent No. 6, AF Solvent No. 7, Naphtesol 160, Naphtesol 200 and Naphtesol 220 (all manufactured by JXTG Nippon Oil & Energy Corporation); Isopar G, Isopar H, Isopar L, Isopar M, Exxsol D40, Exxsol D60, Exxsol D80, Exxsol D95, Exxsol D110 and Exxsol D130 (all manufactured by Exxon Mobil Corporation); and MORESCO White P-40, MORESCO White P-60, MORESCO White P-70, MORESCO White P-80, MORESCO White P-100, MORESCO White P-120, MORESCO White P-150, MORESCO White P-200, MORESCO White P-260 and MORESCO White P-350P (all manufactured by MORESCO Corporation).

Examples of preferred aromatic hydrocarbon solvents include Grade Alkene L and Grade Alkene 200P (both manufactured by JXTG Nippon Oil & Energy Corporation), and Solvesso 100, Solvesso 150, Solvesso 200 and Solvesso 200ND (manufactured by Exxon Mobil Corporation).

The initial boiling point of the petroleum-based hydrocarbon solvent is preferably at least 100° C., more preferably at least 150° C., and even more preferably 200° C. or higher. The initial boiling point can be measured in accordance with JIS K0066 “Test Methods for Distillation of Chemical Products”.

Examples of polar organic solvents that can be used favorably include fatty acid ester-based solvents, higher alcohol-based solvents and higher fatty acid-based solvents.

Specific examples include fatty acid ester-based solvents having at least 13 carbon atoms, and preferably 16 to 30 carbon atoms, within one molecule, such as isononyl isononanoate, isodecyl isononanoate, 2-ethylhexyl isononanoate, methyl laurate, isopropyl laurate, hexyl laurate, isopropyl myristate, isopropyl palmitate, hexyl palmitate, isooctyl palmitate, isostearyl palmitate, methyl oleate, ethyl oleate, isopropyl oleate, butyl oleate, hexyl oleate, methyl linoleate, ethyl linoleate, isobutyl linoleate, butyl stearate, hexyl stearate, isooctyl stearate, isopropyl isostearate, 2-octyldecyl pivalate, methyl soybean oil, isobutyl soybean oil, methyl tallate and isobutyl tallate; higher alcohol-based solvents having at least 6 carbon atoms, and preferably 12 to 20 carbon atoms, within one molecule, such as isomyristyl alcohol, isopalmityl alcohol, isostearyl alcohol,1-octadecanol, oleyl alcohol, isoeicosyl alcohol and decyltetradecanol; and higher fatty acid-based solvents having at least 12 carbon atoms, and preferably 14 to 20 carbon atoms, within one molecule, such as lauric acid, isomyristic acid, palmitic acid, isopalmitic acid, a-linolenic acid, linoleic acid, oleic acid and isostearic acid.

The boiling point of these polar organic solvents such as the fatty acid ester-based solvents, higher alcohol-based solvents and higher fatty acid-based solvents is preferably at least 150° C., more preferably at least 200° C., and even more preferably 250° C. or higher. These non-aqueous solvents having a boiling point of 250° C. or higher also include non-aqueous solvents that do not exhibit an actual boiling point.

These non-aqueous solvents may be used individually, or a combination of two or more solvents may be used, provided the solvents form a single phase.

In addition to the various components described above, the magnetic ink may also include various additives, provided these additives do not impair the effects of the present invention. For example, additives such as nozzle blockage inhibitors, antioxidants, conductivity modifiers, viscosity modifiers, surface tension regulators, and oxygen absorbers and the like may be added as appropriate. There are no particular limitations on these additives, and materials typically used in this technical field may be used.

The ink can be produced by mixing the various components described above. The ink is preferably produced by mixing and stirring the components together, either in a single batch or in a number of separate batches. Specifically, the ink can be produced by dispersing all of the components in a dispersion device such as a beads mill, either in a single batch or in a number of separate batches, and then, if desired, passing the resulting dispersion through a filtration device such as a membrane filter.

The ink according to one embodiment has a low viscosity and good storage stability, and can therefore be used as an inkjet ink.

The ideal range for the viscosity of the inkjet ink varies depending on factors such as the diameter of the nozzles within the discharge head of the inkjet recording system and the discharge environment, but generally, the viscosity at 23° C. is preferably within a range from 5 to 40 mPa·s, more preferably from 5 to 35 mPa·s, and even more preferably from about 10 to 30 mPa·s.

There are no particular limitations on the printing method used with the inkjet ink, provided the magnetic ink is able to be discharged satisfactorily. In those cases where an inkjet recording device is used, the ink is preferably discharged from the inkjet head based on a digital signal, with the discharged ink droplets being adhered to a recording medium.

There are no particular limitations on the recording medium, and printing papers and the like such as plain papers, coated papers and specialty papers may be used.

Here, plain paper describes a normal paper in which an ink receiving layer or film layer or the like has not been formed on the surface of the paper. Examples of plain papers include high-quality papers, medium-quality papers, PPC papers, woody papers and recycled papers. In a plain paper, paper fibers with a thickness of several μm to several tens of μm are formed with a spacing between fibers of several tens to several hundred μm, and therefore the ink can penetrate readily.

Further, in terms of coated papers, coated papers designed for inkjets, such as matte papers, glossy papers and semi-glossy papers, and other so-called coated printing papers can be used favorably. A coated printing paper describes the type of paper that has conventionally been used in relief printing, offset printing, and gravure printing and the like, and is a printing paper in which a coating layer is formed on the surface of a high-quality paper or medium-quality paper using a coating material containing an inorganic pigment such as clay or calcium carbonate and a binder such as starch. Depending on the amount applied of the coating material and the coating method used, coated printing papers are classified into fine coated papers, high-quality lightweight coated papers, medium-quality lightweight coated papers, high-quality coated papers, medium-quality coated papers, art papers, and cast coated papers and the like.

### EXAMPLES

The present invention is described below in further detail using a series of examples. The present invention is in no way limited by the following examples.

### [Preparation of Inks]

Ink formulations are shown in Table 1 and Table 2. The components were mixed in accordance with the component ratios shown in each of the tables. Subsequently, 100 g of 0.5 mm zirconia beads were added, and the mixture was dispersed at 60 Hz for 2 hours using a Rocking Mill manufactured by Seiwa Technical Lab Co., Ltd., thus obtaining an ink.

The components used were as follows.

MnCo ferrite: produced in accordance with the synthesis method described below.

HINOACT KF1300M: a basic dispersant manufactured by Kawaken Fine Chemicals Co., Ltd., active constituent: 100%.

Solsperse 13940: a basic dispersant manufactured by The Lubrizol Corporation, active constituent: 40%.

Isoparaffin-based solvent: Isopar L, manufactured by Exxon Mobil Corporation. 2-ethylhexyl isononanoate: ES108109, manufactured by Kokyu Alcohol Kogyo Co., Ltd.

Aluminum mono(acetylacetonate) bis(ethyl acetoacetate): Aluminum Chelate D manufactured by Kawaken Fine Chemicals Co., Ltd., an isopropanol solution with an active constituent of 76%. In the tables, the amount of the active constituent is shown in parentheses.

Aluminum tris(ethyl acetoacetate): ALCH-TR manufactured by Kawaken Fine Chemicals Co., Ltd., active constituent: 100%.

### [Synthesis of MnCo Ferrite]

A raw material aqueous solution containing cobalt dichloride hexahydrate (CoCl₂.6H₂O), manganese dichloride tetrahydrate (MnCl₂.4H₂O) and ferric chloride hexahydrate (FeCl₃.6H₂O) was added to an aqueous solution of sodium hydroxide and the mixed solution was stirred, and upon stirring, magnetic particles precipitated and were isolated. The isolated, washed and dried magnetic particles had a composition of MnₓCo_{y}Fe₂O₄ (x+y=1, x/y=0.6, average pore size: 26 nm). These particles were used as the MnCo ferrite. For details relating to the synthesis method, reference was made to JP 2012-233053 A.

### [Evaluations]

The inks of the above examples and comparative examples were evaluated using the methods described below. The results of these evaluations are summarized in Table 1 and Table 2.

### (Ink Viscosity)

The ink viscosity was evaluated against the following criteria. The ink viscosity was measured at room temperature (23° C.) using a rheometer ARG2 (manufactured by TA Instruments, Inc.).

A: ink viscosity of less than 30 mPa·s

B: ink viscosity of at least 30 mPa·s

(Redispersed Ink Viscosity after Standing at High Temperature)

First, the viscosity of the ink was measured immediately after ink preparation. Subsequently, 10 mL of the ink was sealed in a screwcap vial and left to stand at 70° C. for one month. The screwcap vial was then agitated, and following confirmation that the precipitate in the lower portion of the vial had redispersed, the ink was sampled, and the redispersed ink viscosity after standing was measured. The change in viscosity was calculated using the formula below, and then evaluated against the following criteria. Measurement of the viscosity was performed using the same method as that described above for the ink viscosity evaluation. A smaller change in viscosity indicates more favorable redispersibility.

Change in viscosity (%)=(viscosity after standing−viscosity immediately after preparation)/viscosity immediately after preparation×100

A: change in viscosity exceeding −15% and less than +15%

B: change in viscosity of −15% or less, or +15% or greater

### (MICR Signal Strength)

Using an inkjet printer ORPHIS EX manufactured by RISO KAGAKU CORPORATION, each of the obtained inks was used to print E13B characters onto a matte paper “RISO Paper U matte (W)” manufactured by RISO KAGAKU CORPORATION. Subsequently, an FB-20 apparatus manufactured by Glory Ltd. was used to read the magnetic ink of the obtained printed item. The signal strength was evaluated against the following criteria. E13B characters are the standard font used for magnetic ink character recognition (MICR).

A: the characters were readable.

B: some characters were unreadable.

C: the characters were unreadable.

TABLE 1
Ink Formulations and Evaluation Results

| Units: % by mass | | Example 1 | Example 2 | Example 3 | Example 4 | Example 5 | Example 6 |
|---|---|---|---|---|---|---|---|
| Magnetic pigment | MnCo Ferrite | 36.0 | 36.0 | 36.0 | 36.0 | 36.0 | 36.0 |
| Dispersant | HINOACT KF1300M | 5.8 | 4.7 | 4.7 | 3.8 | 3.1 | 3.8 |
| | Solsperse 13940 | — | — | — | 4.8 | 4.0 | 4.8 |
| | (active constituent: 40%) | | | | (1.9) | (1.6) | (1.9) |
| Solvent | Isoparaffin-based solvent | 28.6 | 29.1 | 29.3 | 27.2 | 27.9 | 27.2 |
| | 2-ethylhexyl isononanoate | 28.6 | 29.1 | 29.3 | 27.1 | 27.9 | 27.1 |
| Chelate compound | Aluminum mono(acetylacetonate) | 1.1 | 1.1 | 0.7 | 1.1 | 1.1 | — |
| | bis(ethyl acetoacetate) | (0.84) | (0.84) | (0.53) | (0.84) | (0.84) | |
| | (active constituent: 76%) | | | | | | |
| | Aluminum tris(ethyl acetoacetate) | — | — | — | — | — | 1.1 |
| Total (% by mass) | | 100.0 | 100.0 | 100.0 | 100.0 | 100.0 | 100.0 |
| Dispersant/magnetic pigment (% by mass) | | 16 | 13 | 13 | 16 | 13 | 16 |
| Chelate compound*/magnetic pigment (% by mass) | | 2.3 | 2.3 | 1.5 | 2.3 | 2.3 | 2.3 |
| Evaluations | Ink viscosity | A | A | A | A | A | A |
| | Redispersed ink viscosity after | A | A | A | A | A | A |
| | standing at high temperature | | | | | | |
| | MICR signal strength | A | A | A | A | A | A |

*Calculated as the amount of the active constituent

TABLE 2
Ink Formulations and Evaluation Results

| | | | | Comparative | Comparative | Comparative |
|---|---|---|---|---|---|---|
| Units: % by mass | | Example 7 | Example 8 | Example 1 | Example 2 | Example 3 |
| Magnetic pigment | MnCo Ferrite | 38.0 | 30.0 | 36.0 | 36.0 | 36.0 |
| Dispersant | HINOACT KF1300M | 4.9 | 3.9 | 7.2 | 5.8 | 4.7 |
| | Solsperse 13940 | — | — | — | — | — |
| | (active constituent: 40%) | | | | | |
| Solvent | Isoparaffin-based solvent | 28.0 | 32.6 | 28.4 | 29.1 | 29.7 |
| | 2-ethylhexyl isononanoate | 28.0 | 32.6 | 28.4 | 29.1 | 29.7 |
| Chelate compound | Aluminum mono(acetylacetonate) | 1.2 | 0.9 | — | — | — |
| | bis(ethyl acetoacetate) | (0.91) | (0.67) | | | |
| | (active constituent: 76%) | | | | | |
| | Aluminum tris(ethyl acetoacetate) | — | — | — | — | — |
| Total (% by mass) | | 100.0 | 100.0 | 100.0 | 100.0 | 100.0 |
| Dispersant/magnetic pigment (% by mass) | | 13 | 13 | 20 | 16 | 13 |
| Chelate compound*/magnetic pigment (% by mass) | | 2.4 | 2.2 | 0 | 0 | 0 |
| Evaluations | Ink viscosity | A | A | B | B | A |
| | Redispersed ink viscosity after | A | A | B | B | B |
| | standing at high temperature | | | | | |
| | MICR signal strength | A | B | A | A | A |

*Calculated as the amount of the active constituent

As shown in the tables, the inks of the examples each had a low ink viscosity, displayed favorable redispersibility, and also yielded a printed item having high magnetic strength.

In Examples 1 to 3, the blend amounts of the basic dispersants and the aluminum chelate compounds were changed, and favorable results were obtained in each case.

In Examples 4 to 6, the two basic dispersants were combined, and favorable results were obtained in each case.

In Example 6, the type of aluminum chelate compound was changed, and favorable results were obtained.

The results for Examples 2, 7 and 8 confirmed that even when the blend amount of the magnetic pigment differed, favorable results could be obtained.

In Comparative Examples 1 to 3, no aluminum chelate compound was added. In Comparative Examples 1 and 2, the blend amount of pigment dispersant was increased to improve the dispersibility of the magnetic pigment, but the results revealed that the ink viscosity still increased, and the redispersibility was poor.

It is to be noted that, besides those already mentioned above, many modifications and variations of the above embodiments may be made without departing from the novel and advantageous features of the present invention. Accordingly, all such modifications and variations are intended to be included within the scope of the appended claims.

What is claimed is:

1. An oil-based magnetic inkjet ink comprising a magnetic pigment that contains a ferrite, a pigment dispersant, a non-aqueous solvent, and an organometallic chelate compound.

2. The oil-based magnetic inkjet ink according to claim 1, wherein the organometallic chelate compound comprises an organoaluminum chelate compound.

3. The oil-based magnetic inkjet ink according to claim 2, wherein the organoaluminum chelate compound comprises a compound having three polydentate ligands.

4. The oil-based magnetic inkjet ink according to claim 1, wherein an amount of the magnetic pigment is at least 30% by mass relative to a total mass of the ink.
